(19) United States
(12) Patent Application Publication
(10) Pub. No.: US 2026/0054764 A1
(43) Pub. Date: Feb. 26, 2026

(54) WHEELED CHILDCARE DEVICE

(71) Applicant: GRACO CHILDREN'S PRODUCTS INC., Atlanta, GA (US)

(72) Inventors: Hitoshi YABUUCHI, Tokyo (JP); Tomoyuki HONDA, Tokyo (JP); Shozo MATSUSHITA, Tokyo (JP)

(73) Assignee: GRACO CHILDREN'S PRODUCTS INC., Atlanta, GA (US)

(21) Appl. No.: 19/303,074

(22) Filed: Aug. 18, 2025

(30) Foreign Application Priority Data
Aug. 21, 2024 (JP) 2024-139646
Aug. 21, 2024 (JP) 2024-139647
Aug. 21, 2024 (JP) 2024-139648

(51) Int. Cl. B62B 9/08

(52) U.S. Cl. CPC B62B 9/087; B62B 9/082; B62B 2301/04

(57) ABSTRACT

A wheeled childcare device is provided that can reliably reduce or eliminate the possibility of twisting of a wire. The wheeled childcare device includes legs, a caster mechanism, and a brake mechanism. The brake mechanism includes a pair of lock members, an operating member, and a connecting member connecting the operating member with the lock members. The connecting member includes a pair of moving members configured to move in response to an operation of the operating member, an elongated member connecting the operating member with the moving members, and a pair of driven members each configured to be rotatable relative to a corresponding one of the moving members, and each configured to follow movement of the corresponding moving member. Each of the lock members is configured to be displaceable between engaged and disengaged positions in conjunction with movement of the corresponding driven member.

### CROSS-REFERENCE TO RELATED APPLICATIONS

This application claims priority to the following JP Patent Application Nos.: 2024-139646 filed Aug. 21, 2024; 2024-139647 filed Aug. 21, 2024; and 2024-139648 filed Aug. 21, 2024, the entire contents of which are incorporated herein by reference.

### BACKGROUND

The present invention relates to wheeled childcare devices, and more particularly, to a wheeled childcare device including a pair of wheels disposed spaced apart from each other in the width direction of the wheeled childcare device.

Conventionally, strollers with a left-right simultaneous braking mechanism have been known in the art. The left-right simultaneous braking mechanism is a mechanism configured to simultaneously apply a braking force to a pair of casters arranged side by side in the width direction, in response to an operation of a single operating member. For such strollers using casters, a technology has been proposed in which a braking force is applied to the wheels while allowing the casters to swivel.

Japanese Unexamined Patent Application Publication No. 2015-202808 discloses a configuration in which a brake member is provided for each of a pair of casters. Each brake member is connected via a wire and an intermediate member to an operating member provided on a cross member, and a braking force can be simultaneously applied to the pair of casters in response to an operation of the operating member. The brake member is configured to be rotatable relative to the intermediate member to inhibit twisting of the wire.

Japanese Unexamined Patent Application Publication (Translation of PCT Application) No. 2023-548806 discloses a configuration in which a lock member is provided for each of a pair of wheels. Each lock member is connected to an operating member by a first cable and a second cable configured to be rotatable relative to the first cable, and a braking force can be simultaneously applied to the pair of wheels in response to an operation of the operating member. The second cable is configured to be rotatable relative to the first cable to inhibit twisting of the cable.

### SUMMARY

As described above, in both Japanese Unexamined Patent Application Publication No. 2015-202808 and Japanese Unexamined Patent Application Publication (Translation of PCT Application) No. 2023-548806, the wheels are casters, and measured are taken so that the wires (or cables) are not twisted even when the casters rotate. However, in the conventional wheeled childcare devices, friction occurs between components, causing the wire (or cable) to twist as the caster rotates.

The present invention has been made to solve the above problem, and an object of the present invention is to provide a wheeled childcare device that can reliably reduce or eliminate the possibility of twisting of a wire.

In order to achieve the above object, a wheeled childcare device according to an aspect of the present invention includes: a body frame including a pair of legs disposed spaced apart from each other in a width direction; a pair of arm members each having an upper end pivotally held at a lower end of a corresponding one of the pair of legs via a corresponding one of a pair of pivot shafts; a pair of wheels each rotatably supported at a lower end of a corresponding one of the pair of arm members via a corresponding one of a pair of axles; and a brake mechanism configured to stop rotation of the pair of wheels, and including a pair of lock members, an operating member, and a connecting member. Each of the pair of lock members is configured to displace between an engaged position at which the lock member is engaged with the wheel and a disengaged position at which the lock member is disengaged from the wheel. The operating member is configured to move the pair of lock members from the disengaged position to the engaged position. The connecting member connects the operating member with the pair of lock members. The brake mechanism is configured to perform a braking operation and maintain a braking state without being interfered with by a pivoting motion of the pair of arm members.

Preferably, the arm member includes a guide portion that is an elongated hole, and the lock member is configured to be movable along a longitudinal direction of the guide portion.

Preferably, the guide portion is provided on a straight line connecting the pivot shaft and the axle.

Preferably, the connecting member includes a pair of moving members configured to move in response to an operation of the operating member, an elongated member connecting the operating member with the pair of moving members, and a pair of driven members each configured to follow movement of a corresponding one of the pair of moving members.

Preferably, the lock member includes a lock pin that is received by the guide portion, and a lock body extending in a longitudinal direction from the lock pin and configured to be pivotable relative to the driven member.

Preferably. a shaft of the lock member and the pivot shaft of the arm member extend substantially parallel to each other.

Preferably, the wheeled childcare device further includes an arm biasing mechanism configured to bias the arm member in such a direction that the lower end of the arm member approaches the ground.

Preferably, the arm biasing mechanism is an elastic member provided between the leg and the arm member.

Preferably, the connecting member further includes a pair of second biasing members each configured to bias a corresponding one of the pair of moving members in such a direction that a corresponding one of the pair of lock members moves toward the disengaged position.

A wheeled childcare device according to another aspect of the present invention includes: a body frame including a pair of legs disposed spaced apart from each other in a width direction; and a caster mechanism including a pair of caster holding members and a pair of caster pivoting members, and configured to allow a pair of wheels to swivel. Each of the pair of caster holding members is provided at a lower end of a corresponding one of the pair of legs. Each of the pair of caster pivoting members is pivotally held by a corresponding one of the pair of caster holding members about a swivel axis extending in an up-down direction, and supports a corresponding one of the pair of wheels on a shaft. The wheeled childcare device further includes a brake mechanism configured to stop rotation of the pair of wheels, and including a pair of lock members, an operating member, and a connecting member. Each of the pair of lock members is configured to displace between an engaged position at which the lock member is engaged with the wheel and a disengaged position at which the lock member is disengaged from the wheel. The operating member is configured to move the pair of lock members from the disengaged position to the engaged position. The connecting member connects the operating member with the pair of lock members. The connecting member includes: a pair of moving members configured to move in response to an operation of the operating member; an elongated member connecting the operating member with the pair of moving members; and a pair of driven members each configured to be rotatable relative to a corresponding one of the pair of moving members, and each configured to follow movement of the corresponding one of the pair of moving members. Each of the pair of lock members is connected to a corresponding one of the pair of driven members, and is configured to be displaceable between the engaged position and the disengaged position in conjunction with movement of the corresponding one of the pair of driven members.

Preferably, the driven member includes: a rotating member configured to be rotatable relative to the moving member; an up-down moving member configured to be movable in the up-down direction relative to the rotating member; and a first biasing member configured to bias the up-down moving member upward relative to the rotating member.

Preferably, the driven member includes a rotating member provided with a lock support portion that supports a shaft of the lock member. The rotating member is configured to be rotatable relative to the moving member. The driven member further includes a first biasing member configured to bias the lock member in a direction toward the engaged position.

Preferably, the elongated member passes through the swivel axis of the caster mechanism.

Preferably, the connecting member further includes a pair of second biasing members each configured to bias a corresponding one of the pair of moving members in such a direction that a corresponding one of the pair of lock members moves toward the disengaged position.

Preferably, the lock member includes: a lock pin configured to displace between the engaged position and the disengaged position relative to the wheel; and a lock body extending in a longitudinal direction from the lock pin and configured to be pivotable relative to the driven member.

Preferably, the moving member, the driven member, and a shaft of the lock member pass through the swivel axis of the caster mechanism.

A wheeled childcare device according to still another aspect of the present invention includes: a body frame including a pair of legs disposed spaced apart from each other in a width direction; and a caster mechanism including a pair of caster holding members and a pair of caster pivoting members, and configured to allow a pair of wheels to swivel. Each of the pair of caster holding members is provided at a lower end of a corresponding one of the pair of legs. Each of the pair of caster pivoting members is pivotally held by a corresponding one of the pair of caster holding members about a swivel axis extending in an up-down direction. Each of the pair of caster pivoting members supports a corresponding one of the pair of wheels on a shaft. The wheeled childcare device further includes a brake mechanism configured to stop rotation of the pair of wheels, and including a pair of lock members, an operating member, and a connecting member. Each of the pair of lock members is configured to displace between an engaged position at which the lock member is engaged with the wheel and a disengaged position at which the lock member is disengaged from the wheel. The operating member is configured to move the pair of lock members from the disengaged position to the engaged position. The connecting member connects the operating member with the pair of lock members. The connecting member includes: an elongated member passing through a position different from the swivel axis of the caster mechanism; a pair of moving members connected to the elongated member and configured to move in response to an operation of the operating member; and a pair of driven members each configured to be rotatable relative to a corresponding one of the pair of moving members, and each provided with a lock support portion that supports a shaft of a corresponding one of the pair of lock members.

Preferably, the driven member is configured to follow movement of the moving member in the up-down direction.

Preferably, the driven member includes: a rotating member configured to be rotatable relative to the moving member and provided with the lock support portion that supports the shaft of the lock member; and a first biasing member configured to bias the shaft of the lock member in such a direction that the lock member moves toward the engaged position.

Preferably, the rotating member is configured to rotate with the caster pivoting member.

Preferably, the shaft of the lock member is provided at a position offset from the swivel axis of the caster mechanism.

Preferably, the lock support member of the rotating member protrudes beyond an outer peripheral surface of the caster holding member.

The wheeled childcare device of the present invention can reliably reduce or eliminate the possibility of twisting of a wire.

### BRIEF DESCRIPTION OF THE DRAWINGS

FIG. 1 is a perspective view showing part of a wheeled childcare device according to a first embodiment of the present invention.

FIG. 2 is an exploded perspective view showing components around a brake mechanism according to the first embodiment of the present invention.

FIG. 3 is an enlarged sectional view showing part of the components around the brake mechanism according to the first embodiment of the present invention.

FIG. 4 shows perspective views of an operating member according to the first embodiment of the present invention.

FIG. 5 shows the transition from the traveling state to the braking state.

FIG. 6 shows the state in which a load is applied to a body frame in the traveling state.

FIG. 7 shows the state in which a load is applied to the body frame in the braking state.

FIG. 8 is a side view showing components around a brake mechanism according to a second embodiment of the present invention.

FIG. 9 is an exploded perspective view showing the components around the brake mechanism according to the second embodiment of the present invention.

FIG. 10 is an enlarged sectional view showing part of the components around the brake mechanism according to the second embodiment of the present invention.

FIG. 11 shows the transition from a traveling state to a braking state.

FIG. 12 shows the state in which a load is applied to a body frame in the traveling state.

FIG. 13 shows the state in which a load is applied to the body frame in the braking state.

FIG. 14 show partial sectional views of a brake mechanism according to a third embodiment of the present invention.

### DETAILED DESCRIPTION

Embodiments of the present invention will be described in detail with reference to the drawings. The same or corresponding portions are denoted by the same signs throughout the drawings, and description thereof will not be repeated.

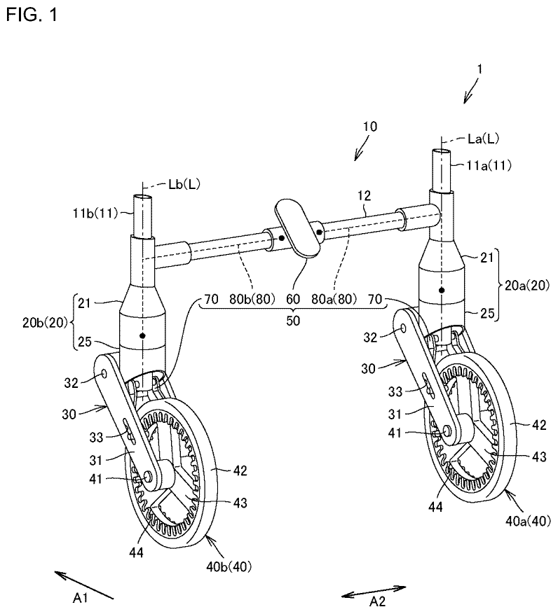

First, a schematic structure of a stroller according to an embodiment will be described with reference to FIGS. 1 to 3. As shown particularly in FIG. 1, a wheeled childcare device according to the embodiment is typically a stroller 1. The stroller 1 generally includes a body frame 10, a pair of caster mechanisms 20, a pair of arm members 30, and a pair of wheels 40. Arrow A1 in FIG. 1 represents the direction of travel of the stroller 1, and arrow A2 represents a direction perpendicular to the direction of travel, and this direction will also be referred to as “width direction” or “left-right direction.”

In the following description, it is assumed that the wheeled childcare device is a stroller. However, this is by way of example, and the wheeled childcare device may be any childcare device that includes a plurality of wheels 40 at the lower end of the body frame 10, such as a baby rocker, a highchair, or a tricycle.

As shown in FIG. 1, the body frame 10 includes a pair of legs 11a, 11b spaced apart from each other in the width direction, and a cross member 12 extending between the pair of legs 11a, 11b. The body frame 10 is typically legs, but may be any member that forms the framework of a childcare device.

Each of a pair of caster mechanisms 20a, 20b is a structure that allows a corresponding one of wheels 40a, 40b to serve as a caster wheel. The pair of caster mechanisms 20a, 20b is provided at the lower ends of the pair of legs 11a, 11b, respectively. In order to distinguish between the right and left legs 11, between the right and left caster mechanisms 20, and between the right and left wheels 40, the right leg 11, the right caster mechanism 20, and the right wheel 40 as viewed from the rear are referred to as “leg 11a,” “caster mechanism 20a,” and “wheel 40a,” and the left leg 11, the left caster mechanism 20, and the left wheel 40 as viewed from the rear are referred to as “leg 11b,” “caster mechanism 20b,” and “wheel 40b.” However, when it is not necessary to distinguish between the right and left legs 11, between the right and left caster mechanisms 20, and between the right and left wheels 40, they are simply referred to as “leg 11,” “caster mechanism 20,” and “wheel 40.”

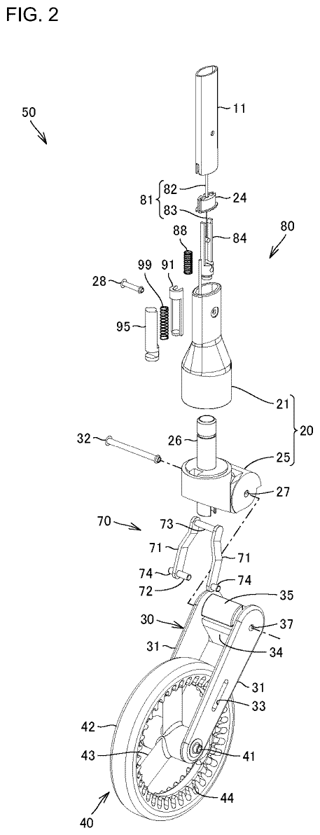

The caster mechanism 20 is a mechanism that allows the wheel 40 to swivel (turn). The caster mechanism 20 includes a caster holding member 21 fixed to the lower end of the leg 11, and a caster pivoting member 25 disposed under the caster holding member 21. The caster holding member 21 includes a longitudinal portion extending in the extending direction of the leg 11, and a transverse portion perpendicular to the longitudinal portion and extending in the extending direction of the cross member 12. The longitudinal portion and the transverse portion both have a tubular shape, and the leg 11 and the cross member 12 are inserted into the longitudinal portion and the transverse portion, respectively. As shown in FIG. 2, the leg 11 is inserted into the caster holding member 21 and secured with a pin 28.

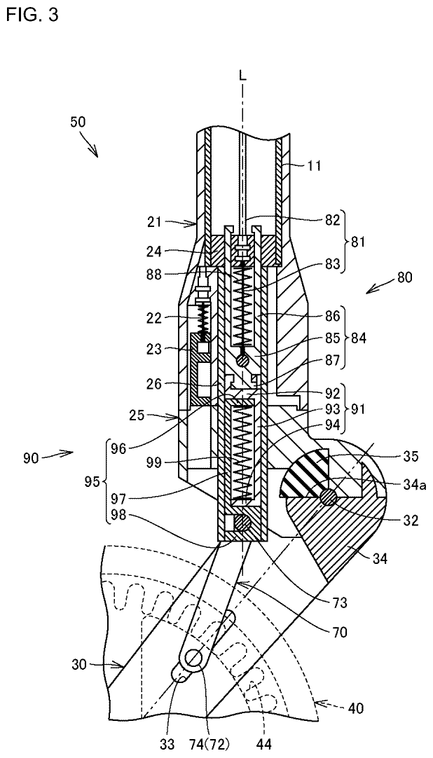

The caster pivoting member 25 is pivotally held by the caster holding member 21 about a swivel axis (turning axis) extending in the up-down direction, and supports the wheel 40 on a shaft via the arm member 30. That is, the caster pivoting member 25 pivots relative to the caster holding member 21. As shown in FIG. 2, for example, a hollow cylindrical caster shaft 26 is fixed to the caster pivoting member 25 and rotates with the caster pivoting member 25. As shown in FIG. 3, the caster shaft 26 extends upward from the upper end of the caster pivoting member 25, and is inserted into the caster holding member 21. A wire holder 24 is fixed to the upper end of the caster shaft 26. The wire holder 25 secures an end of an outer wire 82 described later. As shown in FIG. 2, the caster pivoting member 25 has a hole 27 through which a pivot shaft 32 of the arm member 30 described later passes. The pivot shaft 32 is perpendicular to the extending direction of the caster shaft 26.

As shown in FIG. 1, the upper end of the arm member 30 is pivotally held at the lower end of the leg 11 by the caster pivoting member 25 via the pivot shaft 32. Therefore, the arm member 30 swivels along with the swiveling of the caster pivoting member 25. As shown in FIG. 2, the arm member 30 includes a pair of arm bodies 31 and an arm holding portion 34 connecting the upper ends of the pair of arm bodies 31.

As shown in FIG. 2, the pair of arm bodies 31 is provided at both ends of the wheel 40 in the width direction, and is shaped to sandwich the wheel 40 from both sides in the width direction. The pair of arm bodies 31 are elongated plates having substantially the same shape and extending in the up-down direction. Each arm body 31 is inclined forward in the direction of travel. Each arm body 31 has three through holes, including a hole 37 provided in the upper end of the arm body 31, an elongated hole 33 provided substantially in the middle part of the arm body 31, and a hole (not shown) provided in the lower end of the arm body 31 to support an axle 41.

The pivot shaft 32 for pivotally attaching the arm member 30 to the caster pivoting member 25 passes through the hole 37. The pivot shaft 32 passes through the hole 27 of the caster pivoting member 25 and the hole 37 of the arm member 30. The arm member 30 and the caster pivoting member 25 are thus pivotally connected together. As shown in FIG. 3, the elongated hole 33 is provided on a straight line connecting the pivot shaft 32 and the axle 41 of the wheel 40 (shown by a long dashed double-short dashed line). The elongated hole 33 serves as a guide portion that guides movement of a lock member 70 described later. In the present embodiment, the lock member 70 passes through the elongated hole 33. However, the elongated hole 33 may be in any form as long as it guides movement of the lock member 70. For example, the elongated hole 33 may be an elongated groove. The elongated hole 33 is provided substantially in the middle part of the arm body 31. However, the elongated hole 33 may be provided at any position as long as it is at least provided on the straight line connecting the pivot shaft 32 and the axle 41 of the wheel 40.

As shown in FIG. 2, the arm holding portion 34 holds the pair of arm bodies 31 spaced apart in the width direction. Since the arm holding portion 34 is provided, the arm member 30 forms an inverted U-shape when viewed from the direction of travel. As shown in FIG. 3, the arm holding portion 34 is provided with a base portion 34a having a generally mirrored L-shaped cross-section. The corner of the base portion 34a aligns with the pivot shaft 32. An elastic member 35 made of, for example, synthetic resin rubber is disposed on the base portion 34a.

The elastic member 35 is disposed between the leg 11 and the arm member 30, more specifically between the caster pivoting member 25 and the base portion 34a of the arm holding portion 34. The elastic member 35 has a flat surface that contacts the base portion 34a, and an arc-shaped surface that contacts the lower end of the caster pivoting member 25. The elastic member 35 is an arm biasing member that biases the arm member 30 in such a direction that the lower end of the arm member 30 approaches the ground. In other words, the elastic member 35 is an arm biasing member that biases the arm member 30 in such a direction that the upper end of the arm member 30 moves away from the ground. The upper end of the arm member 30 is the end located farther from the ground, and is the end where the pivot shaft 32 is provided. The elastic member 35 serves also as a shock absorbing member that absorbs the impact caused by a load applied to the body frame 10, a level difference on a road surface, etc.

The wheel 40 includes the axle 41, a tire 42 that rotates about the axle 41, a wheel 43 that holds the inner periphery of the tire 42, and a plurality of lock protrusions 44 provided along the inner periphery of the tire 42. The lock protrusions 44 of the present embodiment are, for example, ribs. The plurality of lock protrusions 44 extends in a radial pattern from the axle 41. When a lock pin 72 of the lock member 70 described later is located between adjacent lock protrusions 44, the rotation of the wheel 40 is prohibited, and a braking state is attained. A brake mechanism 50 is provided as a mechanism for prohibiting the rotation of each wheel 40 to attain a braking state.

Hereinafter, an example of the brake mechanism 50 used in the stroller 1 will be described in detail.

### First Embodiment

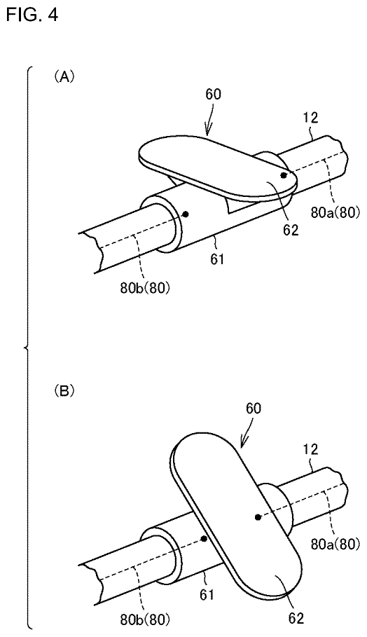

The configuration and operation of the brake mechanism according to the embodiment will be described in detail with further reference to FIG. 4.

The brake mechanism 50 is configured to perform a braking operation and maintain the braking state without being interfered with by the pivoting motion of the pair of arm members 30. As shown particularly in FIG. 1, the brake mechanism 50 is a mechanism for applying a braking force to the pair of wheels 40, and generally includes an operating member 60, a pair of lock members 70, and a connecting member 80 that connects the pair of lock members 70. The brake mechanism 50 is a so-called single-action brake that can simultaneously apply a braking force to the pair of wheels 40 in response to an operation of the operating member 60. Hereinafter, each configuration will be described in detail.

### Operating Member

The operating member 60 is a member that is operated to move the pair of lock members 70 from an engaged position to a disengaged position. A braking force can be applied by merely operating the single operating member 60. The operating member 60 is connected to the connecting member 80. When the operating member 60 is operated, the connecting member 80 is pulled upward, so that the pair of lock members 70 can be moved from the disengaged position to the engaged position. An existing structure is adopted for the connection between the operating member 60 and the connecting member 80.

As shown in FIG. 4, the user operates the operating member 60 to switch the stroller 1 between the braking state and the traveling state. Typically, the operating member 60 includes a user operation portion 62 that can assume two attitudes. The user operation portion 62 may have various structures, but in the present embodiment, the user operation portion 62 is in the shape of an elongated flat plate that protrudes rearward beyond the cross member 12. The user operation portion 62 is connected to a holding portion 61 having a generally tubular cross-section, and is pivotally connected to the cross member 12 via the holding portion 61.

As shown in FIG. 4, when the operating member 60 is positioned substantially horizontally on the cross member 12, the stroller 1 is in the traveling state. As shown in FIG. 4, when the operating member 60 is positioned on the rear side of the cross member 12 and tilted at substantially 45 degrees from the substantially horizontal attitude, the stroller 1 is in the braking state.

The user operation portion 62 protrudes rearward beyond the cross member 12. Therefore, when applying a braking force to the stroller 1, the user can change the attitude of the user operation portion 62 to the second attitude by pressing down on the upper surface of the user operation portion 62 with their foot etc. When releasing the stroller 1 from the braking state, the user can change the attitude of the user operation portion 62 to the first attitude by pushing up the back side of the user operation portion 62 with their foot etc.

### Pair of Lock Members

The pair of lock members 70 is provided to stop the rotation of the pair of wheels 40. Each of the pair of lock members 70 is configured to displace between the engaged position at which it is engaged with a corresponding one of the pair of wheels 40 and the disengaged position at which it is disengaged from the corresponding wheel 40. As shown in FIG. 2, the lock member 70 includes a pair of lock bodies 71, a lock pin 72 that is received by the elongated hole 33 of the arm member 30, a pair of guide pins 74 that protrudes toward both sides in the width direction from the lower ends of the pair of lock bodies 71, and a shaft 73 that connects the upper ends of the pair of lock bodies 71.

The pair of lock bodies 71 is rod-shaped members extending in the up-down direction, and is located between the arm member 30 and the wheel 40. The lock pin 72 is provided on the lower end of only one of the pair of lock bodies 71 (the left lock body 71 in FIG. 2), and protrudes toward the lock protrusions 44 of the wheel 40. Each of the pair of guide pins 74 is provided on the lower end of a corresponding one of the pair of lock bodies 71, and passes through a corresponding one of the elongated holes 33 of the arm member 30. The lock member 70 is thus movable only along the extending direction of the elongated holes 33 of the arm member 30. The pair of guide pins 74 and the lock pin 72 are disposed coaxially.

In the present embodiment, the lock pin 72 is provided on only one of the pair of lock bodies 71. However, the lock pin 72 may be provided on both of the pair of lock bodies 71. In the present embodiment, the lock pin 72 and the pair of guide pins 74 are provided separately but coaxially. However, the lock pin 72 may function as the guide pin 74. That is, the lock pin 72 may be guided by the elongated hole 33.

The shaft 73 is provided on the upper ends of the pair of lock bodies 71 and secures the pair of lock bodies 71. This allows the pair of lock bodies 71 to always move in the same manner. As shown in FIG. 2, the extending direction of the shaft 73 and the extending direction of the lock pin 72 and the guide pins 74 are substantially parallel. The extending direction of the shaft 73 of the lock member 70 and the extending direction of the pivot shaft 32 of the arm member 30 are also substantially parallel. The shaft 73 is connected to a driven member 90 described later, and is displaced in conjunction with movement of the driven member 90. The driven member 90 will be described later.

### Connecting Member

The connecting member 80 connects the operating member 60 and the pair of lock members 70. As shown in FIG. 1, a connecting member 80a is connected at its one end to the operating member 60, passes through the interior of the cross member 12, passes through the swivel axis La of the caster mechanism 20a, and is indirectly connected at its other end to the lock member 70 of the wheel 40a. A connecting member 80b is connected at its one end to the operating member 60, passes through the interior of the cross member 12, passes through the swivel axis Lb of the caster mechanism 20b, and is indirectly connected at its other end to the lock member 70 of the wheel 40b. When the operating member 60 is operated, the connecting members 80a, 80b are pulled upward, and the lock members 70 are displaced from the disengaged position to the engaged position.

In order to distinguish between the right and left connecting members 80 and between the right and left swivel axes L, the right connecting member 80 and the right swivel axis L as viewed from the rear are referred to as “connecting member 80a” and “swivel axis La,” and the left connecting member 80 and the left swivel axis L as viewed from the rear are referred to as “connecting member 80b” and “swivel axis Lb.” However, when it is not necessary to distinguish between the right and left connecting members 80 and between the right and left swivel axes L, they are simply referred to as “connecting member 80” and “swivel axis L.” The connecting member 80 may be any member as long as it connects the operating member 60 and the lock members 70. The connecting member 80 may connect the lock members 70 to each other through (via) the operating member 60.

The connecting member 80 includes a plurality of members. Specifically, the connecting member 80 includes an elongated member 81, a pair of moving members 84, and a pair of driven members 90.

The elongated member 81 is a member that connects the operating member 60 and the pair of moving members 84. The elongated member 81 extends in its longitudinal direction. The elongated member 81 of the present embodiment includes two wires. However, the elongated member 81 may include one wire. As shown in FIG. 3, the elongated member 81 includes an outer wire 82 and an inner wire 83 provided inside the outer wire 82. The outer wire 82 is fixed to the cross member 12 and the wire holder 24. The inner wire 83 is configured to be movable inside the outer wire 82. The other end of the inner wire 83 is fixed to the moving member 84. The elongated member 81 passes through the swivel axis L.

The moving member 84 moves in response to an operation of the operating member 60. As shown in FIG. 3, an end of the elongated member 81 is connected to a wire fixing portion 85 that is located at the lower end of the moving member 84. The moving member 84 is substantially entirely disposed in the caster shaft 26 so as to be movable in the up-down direction. A pair of protruding portions 86 protruding upward from the wire fixing portion 85 is provided to guide the movement of the moving member 84. An engaging portion 87 that engages with a rotating member 91 described below is provided under the wire fixing portion 85. Irregularities are provided on the outer peripheral surface of the engaging portion 87 to allow the rotating member 91 to rotate.

A second biasing member 88 is, for example, a spring, and is typically a compression coil spring. The second biasing member 88 is disposed between the wire holder 24 and the moving member 84. Specifically, the upper end of the second biasing member 88 contacts the wire holder 24, and the lower end of the second biasing member 88 contacts the wire fixing portion 85 of the moving member 84. Therefore, the second biasing member 88 biases the moving member 84 toward a lower position and biases the lock member 70 in a direction toward the disengaged position.

The driven member 90 follows the movement of the moving member 84. That is, when the moving member 84 moves to an upper position, the driven member 90 also moves upward. When the moving member 84 moves to a lower position, the driven member 90 also moves downward. The driven member 90 is configured to be rotatable relative to the moving member 84. Therefore, even when the caster pivoting member 25 swivels relative to the caster holding member 21, the moving member 84 does not rotate, and only the driven member 90 rotates relative to the moving member 84. This configuration can reduce or eliminate the possibility of twisting of the wires.

The driven member 90 of the present embodiment includes a plurality of members. The driven member 90 includes, for example, a rotating member 91 configured to be rotatable relative to the moving member 84, an up-down moving member 95 configured to rotate with the rotating member 91 and to be movable in the up-down direction relative to the rotating member 91, and a first biasing member 99 that biases the up-down moving member 95 upward relative to the rotating member 91.

As shown in FIG. 3, an engaged portion 92 that is rotatably engaged with the engaging portion 87 of the moving member 84 is provided at the upper end of the rotating member 91. The engaged portion 92 has an irregular shape and is rotatably engaged with the irregularities of the engaging portion 87. The rotating member 91 also includes a longitudinal portion 93 extending downward from the engaged portion 92, and a lower horizontal portion 94 protruding horizontally from the lower end of the longitudinal portion 93. As shown in FIG. 2, the longitudinal portion 93 and the lower horizontal portion 94 form an opening that opens horizontally.

A support portion 98 that supports the shaft 73 of the lock member 70 is provided at the lower end of the up-down moving member 95. The up-down moving member 95 further includes a longitudinal portion 97 extending upward from the support portion 98, and an upper horizontal portion 96 protruding horizontally from the upper end of the longitudinal portion 97. As shown in FIG. 2, the longitudinal portion 97 and the upper horizontal portion 96 form an opening that opens horizontally. The up-down moving portion 95 is configured to rotate with the rotating member 91 and to be movable in the up-down direction relative to the rotating member 91.

As shown in FIG. 3, the first biasing member 99 is disposed in a space formed by arranging the opening of the rotating member 91 and the opening of the up-down moving member 95 such that the openings face each other. The first biasing member 99 is, for example, a spring, and is typically a compression coil spring. The upper end of the first biasing member 99 contacts the upper horizontal portion 96 of the up-down moving member 95, and the lower end of the first biasing member 99 contacts the lower horizontal portion 94 of the rotating member 91. Accordingly, the first biasing member 99 biases the up-down moving member 95 upward relative to the rotating member 91, and biases the lock member 70 in a direction toward the engaged position.

As described above, as shown in FIG. 3, the second biasing member 88, the moving member 84, and the driven member 90 (rotating member 91, up-down movable member 95, and first biasing member 99) are arranged inside the caster shaft 26 in this order from the top. The moving member 84, the second biasing member 88, and the driven member 90 (rotating member 91, up-down moving member 95, and first biasing member 99) pass through the swivel axis L.

### Other Configurations

The structure around the brake mechanism 50 will be described with reference to FIG. 3.

As described above, the caster mechanism 20 is configured so that the caster pivoting member 25 can swivel relative to the caster holding member 21. A caster lock 23 is provided to control the swiveling. The caster lock 23 is disposed inside the caster holding member 21 at a position adjacent to the caster shaft 26, that is, at a position offset from the swivel axis L.

The caster lock 23 is located in an upper position shown in FIG. 3 when it permits rotation of the caster about the swivel axis. The caster lock 23 is located in a lower position, not shown, inside the caster pivoting member 25 when it prohibits rotation of the caster about the swivel axis. The caster lock 23 is connected to one end of a wire 22. The other end of the wire 22 is connected to an operating portion for the caster lock 23 that is provided at any desired position such as on a push bar. Swiveling of the caster lock 23 can be prohibited or permitted by operating the operating portion. An existing conventional method can be used for the caster lock 23.

### Operation

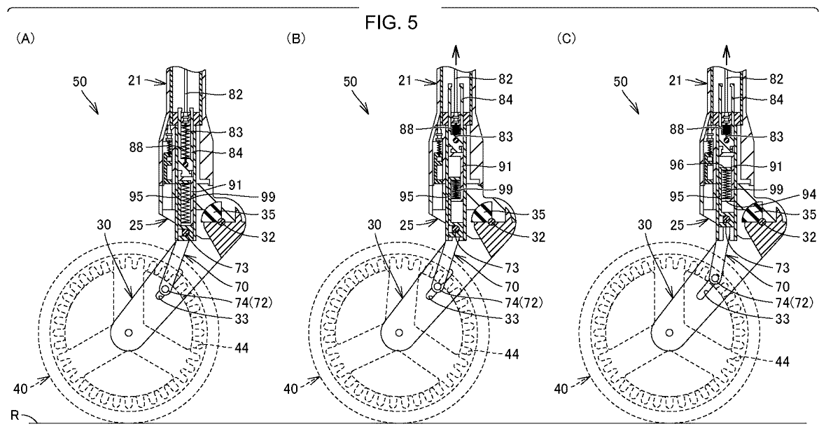

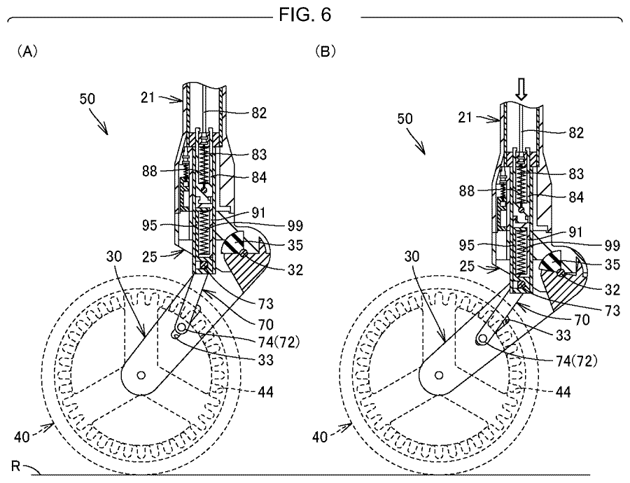

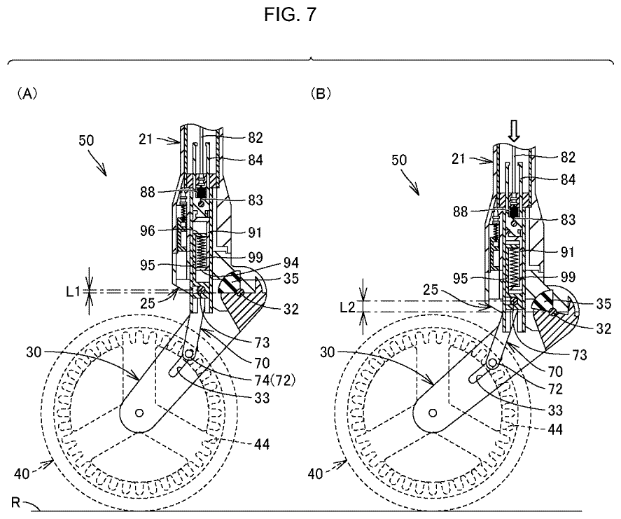

The operation of the brake mechanism 50 according to the present embodiment will be described with reference to FIGS. 5 to 7. FIG. 5 shows the transition from the traveling state to the braking state. FIG. 6 shows the state in which a load is applied to the body frame in the traveling state. FIG. 7 shows the state in which a load is applied to the body frame in the braking state.

First, the operation for switching the stroller 1 from the traveling state to the braking state will be described with reference to FIG. 5. FIG. 5 shows the traveling state in which the lock pin 72 of the lock member 70 is disengaged from between the lock protrusions 44 of the wheel 40. In order to switch the stroller 1 from this state to the braking state, the operating member 60 shown in FIG. 4 is pressed down with a foot etc., thereby pulling the connecting member 80 upward. As a result, as shown in FIG. 5, the inner wire 83 is pulled upward. Since the inner wire 83 is fixed to the moving member 84, the moving member 84 moves upward against the biasing force of the second biasing member 88. Moreover, since the moving member 84 is connected to the rotating member 91 so as to be rotatable and movable in the up-down direction, the rotating member 91 moves upward with the moving member 84.

Since the up-down moving member 95 is connected to the rotating member 91 so as to be movable in the up-down direction, the up-down moving member 95 tries to move upward along with the upward movement of the rotating member 91. However, the up-down moving member 95 is connected to the lock member 70 via the shaft 73. As shown in FIG. 5, the lock pin 72 of the lock member 70 is in contact with the distal end of a lock protrusion 44. In this state, the lock member 70 cannot move upward from that position. Accordingly, the up-down moving member 95 connected to the lock member 70 remains in a lower position due to the position of the lock member 70. The rotating member 91 moves upward along with the inner wire 83, whereas the up-down moving member 95 remains in the lower position due to the lock pin 72 being in contact with the distal end of the lock protrusion 44. Therefore, the first biasing member 99 that biases the up-down moving member 95 upward is contracted, and the up-down moving member 95 is constantly biased upward.

For example, when the wheel 40 rotates from the state shown in FIG. 5, the positional relationship between the lock pin 72 and the lock protrusions 44 changes. As described above, the up-down moving member 95 is biased upward by the first biasing member 99. Therefore, when the positional relationship between the lock pin 72 and the lock protrusions 44 changes and the lock pin 72 faces a recess between the lock protrusions 44, there is no longer an obstacle to the upward movement of the up-down moving member 95. Accordingly, as shown in FIG. 5, the up-down moving member 95 is moved upward by the biasing force of the first biasing member 99, and the lock pin 72 is fitted between the lock protrusions 44, whereby the braking state is attained.

The positional relationship between the rotating member 91 and the up-down moving member 95 of the driven member 90 is different between the traveling state (FIG. 5) and the transitional state from the traveling state to the braking state. In the traveling state shown in FIG. 5, the lower horizontal portion 94 of the rotating member 91 and the upper horizontal portion 96 of the up-down moving member 95 are fully separated, and the first biasing member 99 is extended. However, in the transitional state from the traveling state to the braking state shown in FIG. 5, the lower horizontal portion 94 of the rotating member 91 and the upper horizontal portion 96 of the up-down moving member 95 are closer to each other than in the traveling state, and the first biasing member 99 is contracted. That is, even in the transitional state from the traveling state to the braking state, the first biasing member 99 constantly biases the lock member 70 toward the engaged position.

The brake mechanism 50 of the present embodiment is provided with the first biasing member 99 between the rotating member 91 and the up-down moving member 95. Therefore, even when a braking force cannot be applied due to the change in the positional relationship between the lock pin 72 and the lock protrusions 44 of the wheel 40 as shown in FIG. 5, the operating force of the operating member 60 is transmitted to the lock member 70 through a plurality of members, and is not directly transmitted to the lock member 70. This can avoid a situation where it is difficult to apply the brake, and therefore can reduce the possibility of malfunction of the members constituting the brake mechanism 50.

Next, the operation when a load is applied to the leg 11 in the traveling state will be described with reference to FIG. 6. FIG. 6 shows the traveling state in which the lock pin 72 of the lock member 70 is disengaged from between the lock protrusions 44 of the wheel 40.

As shown in FIG. 6, when a load is applied to the leg 11 etc. in this state due to, for example, movement of an infant riding in the stroller 1, the arm member 30 held by the caster pivoting member 25 pivots about the pivot shaft 32, and the elastic member 35 is pressed against the lower surface of the caster pivoting member 25. As a result, the tilt angle of the arm member 30 with respect to the road surface R decreases. At the same time, the caster mechanism 20 approaches the wheel 40. Therefore, the guide pin 74 moves slightly downward along the elongated hole 33. The elastic member 35 biases the arm member 30 in such a direction that the upper end of the arm member 30 moves away from the ground, that is, in such a direction that the tilt angle of the arm member 30 with respect to the road surface R increases. Therefore, when the load is no longer applied to the leg 11 etc., the arm member 30 returns to the state shown in FIG. 6 due to the elastic force of the elastic member 35.

As described above, the elastic member 35 is provided between the arm member 30 and the caster pivoting member 25. Therefore, even when a load is applied to the stroller 1, the load can be absorbed by the elastic member 35. This operation is an operation that takes place even when there is, for example, a level difference on a road surface, and may also apply in the case of FIG. 7 described below.

Lastly, the operation when a load is applied to the leg 11 in the braking state will be described with reference to FIG. 7. FIG. 7 shows the braking state in which the lock pin 72 of the lock member 70 is fitted between the lock protrusions 44 of the wheel 40. In the braking state, the lower horizontal portion 94 of the rotating member 91 and the upper horizontal portion 96 of the up-down moving member 95 are closer than in the traveling state. Therefore, the first biasing member 99 that biases the up-down moving member 95 upward is contracted, and the up-down moving member 95 is constantly biased upward.

As shown in FIG. 7, when a load is applied to the leg 11 etc. in this state due to, for example, movement of an infant riding in the stroller 1, the arm member 30 held by the caster pivoting member 25 pivots about the pivot shaft 32, and the elastic member 35 is pressed against the lower surface of the caster pivoting member 25. As a result, the tilt angle of the arm member 30 with respect to the road surface R decreases. The positional relationship between the pivot shaft 32 and the shaft 73 also changes. Specifically, the height difference between the pivot shaft 32 and the shaft 73 increases from L1 to L2 (L2>L1). Namely, the shaft 73 moves away from the pivot shaft 32. The positional relationship between the arm member 30 and the lock member 70 changes in this manner. Since the up-down moving member 95 is constantly biased upward by the first biasing member 99, the shaft 73 and the up-down moving member 95 are moved upward by the first biasing member 99. That is, the shaft 73 and the up-down moving member 95 are moved upward with respect to the pivot shaft 32 by the first biasing member 99 according to the rotation of the arm member 30. Therefore, even when a load is applied to the stroller 1, the braking state in which the lock pin 72 of the lock member 70 is fitted between the lock protrusions 44 of the wheel 40 can be maintained.

As described above, the first biasing member 99 is provided between the up-down moving member 95 and the rotating member 91. Therefore, even when a load is applied to the stroller 1 in the braking state, the braking state can be maintained. Moreover, since the first biasing member 99 is provided between the up-down moving member 95 and the rotating member 91, the load applied to the stroller 1 can be absorbed by the first biasing member 99.

### Effects

In the brake mechanism 50 of the present embodiment, each of the pair of arm members 30 is rotatably held via a corresponding one of the pivot shafts 32 at the lower end of a corresponding one of the pair of caster pivoting members 25. Therefore, the brake mechanism 50 is not interfered with by the pivoting motion of the pair of arm members 30. Moreover, even when a load is applied to the stroller 1 and the pair of arm members 30 pivots about their pivot shafts 32, a braking operation can be performed using the operating member 60, and the braking state can be reliably maintained.

Since the guide pin 74 of the lock member 70 is configured to move along the elongated hole 33 of the arm member 30, it is possible to restrict the lock pin 72 from moving to a position other than the elongated hole 33. When a load is applied to the stroller 1, the arm member 30 and the lock member 70 rotate in the same direction. However, since the pivot shaft 32 and the shaft 73 extend substantially parallel to each other, their movements are not hindered.

Since the driven member 90 to which the lock member 70 is connected is rotatable relative to the moving member 84 to which the elongated member 81 is connected, the moving member 84 does not rotate along with the rotation of the caster pivoting member 25. This configuration can reduce or eliminate the possibility of twisting of the wires. Since the driven member 90 is constituted by three members, namely the rotating member 91, the up-down moving member 95, and the first biasing member 99, the braking state can be maintained even when a load is applied to the body frame 10. Moreover, since the load can be absorbed by the expansion and contraction of the first biasing member 99, the impact on the infant riding the stroller 1 can be reduced.

The elongated member 81 passes through the swivel axis L of the caster holding member 21, and the moving member 84 of the connecting member 80, the driven member 90 (rotating member 91 and up-down moving member 95), the first biasing member 99, and the second biasing member 88 all pass through the swivel axis L of the caster mechanism 20. This configuration can reduce or eliminate the possibility of twisting of the elongated member 81 even when the caster pivoting member 25 pivots relative to the caster holding member 21. Moreover, the above components are housed within the caster shaft 26, which facilitates disassembly and assembly.

### Modifications

In the above embodiment, the driven member 90 includes the rotating member 91, the up-down moving member 95, and the first biasing member 99. Namely, the driven member 90 is constituted by a plurality of members. However, the driven member 90 may alternatively be integrally formed as a single member. The driven member 90 may have any structure as long as the driven member 90 is configured to be rotatable relative to the moving member 84 and to follow the movement of the moving member 84.

In the above embodiment, the arm biasing mechanism 35 is an elastic member. However, the arm biasing mechanism 35 may be any member that biases the arm member 30 in such a direction that the lower end of the arm member 30 approaches the ground. The arm biasing mechanism 35 is not limited to a member that biases the arm member 30 in such a direction that the lower end of the arm member 30 approaches the ground by using a material such as rubber as in the above embodiment. The arm biasing mechanism 35 may be a member that electrically or mechanically biases the arm member 30. The position where the arm biasing mechanism 35 is disposed is also not limited to the above embodiment. The arm biasing mechanism 35 may be disposed at any position between the leg 11 and the arm member 30.

### Second Embodiment

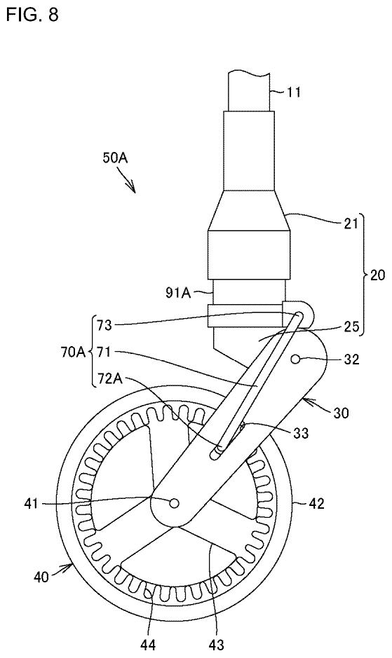

The configuration and operation of a brake mechanism 50A according to a second embodiment will be described with reference to FIGS. 8 to 10. The brake mechanism 50A of the present embodiment has the same basic configuration as the brake mechanism 50 of the first embodiment. The brake mechanism 50A of the present embodiment is different from the brake mechanism 50 of the first embodiment in the configurations of a moving member 84A, a rotating member 91A, a cooperative member 96A, and a lock member 70A, and a portion into which the elongated member 81 is inserted. The same configurations as those of the brake mechanism 50 of the first embodiment are denoted by the same signs, and only the differences will be described in detail.

### Configurations

In the brake mechanism 50A of the present embodiment, the elongated member 81 of a connecting member 80A is provided at a position offset from the swivel axis L of the caster mechanism 20. Specifically, the elongated member 81 is not inserted into the caster shaft 26 passing through the swivel axis L of the caster mechanism 20. Instead, the elongated member 81 passes through a portion adjacent to the caster shaft 26. The elongated member 81 is disposed at a position facing the caster lock 23 described above with the caster shaft 26 interposed therebetween.

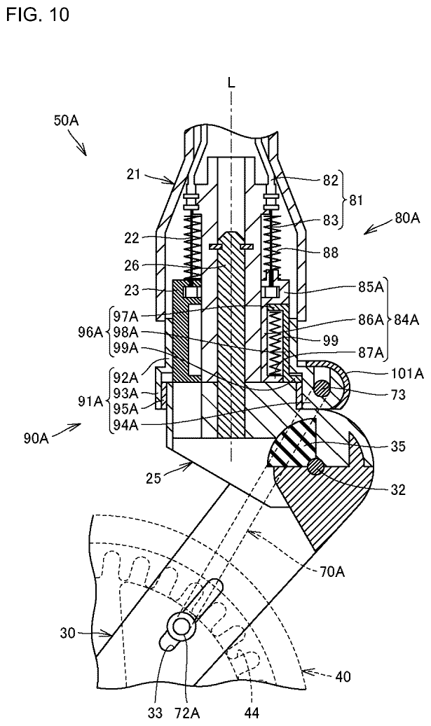

Like the moving member 84 of the first embodiment, the moving member 84A moves in response to an operation of the operating member 60. As shown in FIG. 10, an end of the elongated member 81 is connected to a wire fixing portion 85A that is located at the upper end of the moving member 84A. The moving member 84A is movable in the up-down direction, and includes a longitudinal portion 86A extending downward from the wire fixing portion 85A, and a lower horizontal portion 87A protruding horizontally from the lower end of the longitudinal portion 86A. The longitudinal portion 86A and the lower horizontal portion 87A form an opening that opens outward in the radial direction.

A driven member 90A follows the movement of the moving member 84A. That is, when the moving member 84A moves to an upper position, the driven member 90A also moves upward. When the moving member 84A moves to a lower position, the driven member 90A also moves downward. The driven member 90A of the present embodiment is constituted by a plurality of members, and includes, for example, the rotating member 91A and the first biasing member 99. The rotating member 91A is configured to be rotatable relative to the moving member 84A.

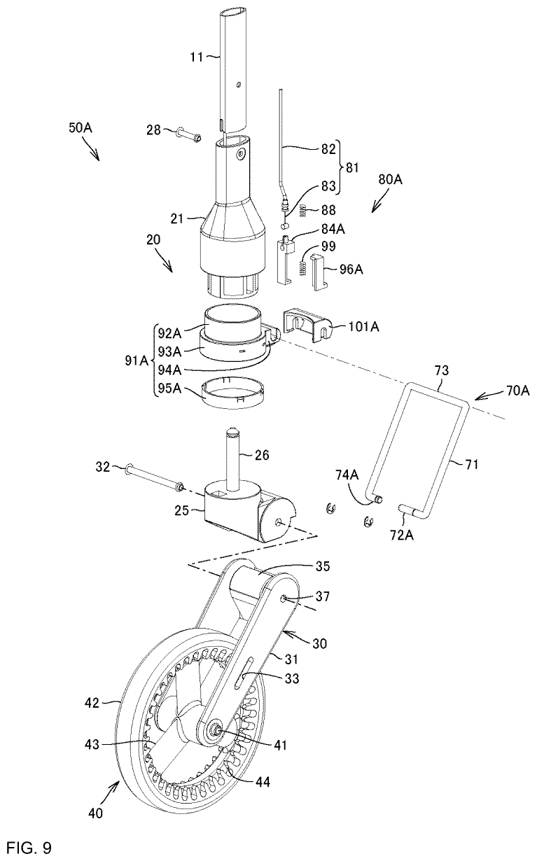

As shown in FIGS. 9 and 10, the rotating member 91A has a generally tubular shape, and is interposed between the caster holding member 21 and the caster pivoting member 25 of the caster mechanism 20. Specifically, the rotating member 91A includes: an upper housing 92A that is in contact with the caster holding member 21; a lower housing 93A located under the upper housing 92A; a lock support portion 94A provided on part of the outer peripheral surface of the lower housing 93A to support the lock member 70A; and a ring portion 95A provided between the lower housing 93A and the caster pivoting member 25. The rotating member 91A is fixed to the caster pivoting member 25 and rotates with the caster pivoting member 25. Although the rotating member 91A has been described as having a tubular shape, the rotating member 91A may have a shape in which a portion in the circumferential direction of the rotating member 91A is cut away. The shape of the rotating member 91A is not limited.

As shown particularly in FIG. 10, the upper housing 92A is in contact with the inner peripheral surface of the caster holding member 21 and is configured to be movable in the up-down direction. The lower housing 93A has a larger outer diameter than the upper housing 92A. The outer diameter of the lower housing 93A is substantially the same as the diameter of the outer peripheral surface of the caster holding member 21. A step is provided between the lower housing 93A and the upper housing 92A. The lock support portion 94A is in the form of, for example, a recess, and rotatably holds the shaft 73 extending in the width direction. The upper side of the lock support portion 94A is covered by a cover 101A. The lock support portion 94A protrudes outward from the outer peripheral surface of the caster holding member 21. The ring portion 95A connects the lower housing 93A and the caster pivoting member 25, and fills the gap between the lower housing 93A and the caster pivoting member 25.

The cooperative member 96A is a member that moves in the up-down direction with the rotating member 91A but does not rotate with the rotating member 91A. The cooperative member 96A includes: an upper horizontal portion 97A protruding inward in the radial direction; a longitudinal portion 98A extending downward from the upper horizontal portion 97A; and a lower horizontal portion 99A protruding outward in the radial direction from the lower end of the longitudinal portion 98A. As shown in FIG. 9, the upper horizontal portion 97A and the longitudinal portion 98A form an opening that opens inward in the radial direction. The lower horizontal portion 99A contacts the lock support portion 94A of the rotating member 91A. The cooperative member 96A and the rotating member 91A are thus configured to be movable in the up-down direction. The cooperative member 96A is a different component from the rotating member 91A. However, the cooperative member 96A and the rotating member 91A may be provided as a single member as long as the cooperative member 96A is configured not to rotate relative to the rotating member 91A.

The first biasing member 99 is disposed in a space formed by arranging the opening of the moving member 84A and the opening of the cooperative member 96A such that the openings face each other. The upper end of the first biasing member 99 is in contact with the upper horizontal portion 97A of the cooperative member 96A, and the lower end of the first biasing member 99 is in contact with the lower horizontal portion 87A of the moving member 84A. The first forceable member 99 thus biases the rotating member 91A upward relative to the moving member 84A, and biases the lock member 70A in a direction toward the engaged position.

As described above, the second biasing member 88, the moving member 84A, and the driven member (rotating member 91A, first biasing member 99, cooperative member 96A) are arranged in this order from above at a position adjacent to the caster shaft 26, that is, at a position different from the swivel axis L.

As shown in FIG. 9, a lock pin 72A is provided at the distal end of one of the lock bodies 71 of the lock member 70A, and a lock guide 74A is provided at the distal end of the other lock body 71. The lock pin 72A protrudes by a greater length than the lock guide 74A, and also serves as a lock guide. Specifically, the lock pin 72A is long enough to pass through the elongated hole 33 and reach a lock protrusion 44 of the wheel 40. The shaft 73 of the lock member 70A is provided at a position offset from the swivel axis L, and is located radially outward of the outer peripheral surface of the caster holding member 21.

### Operation

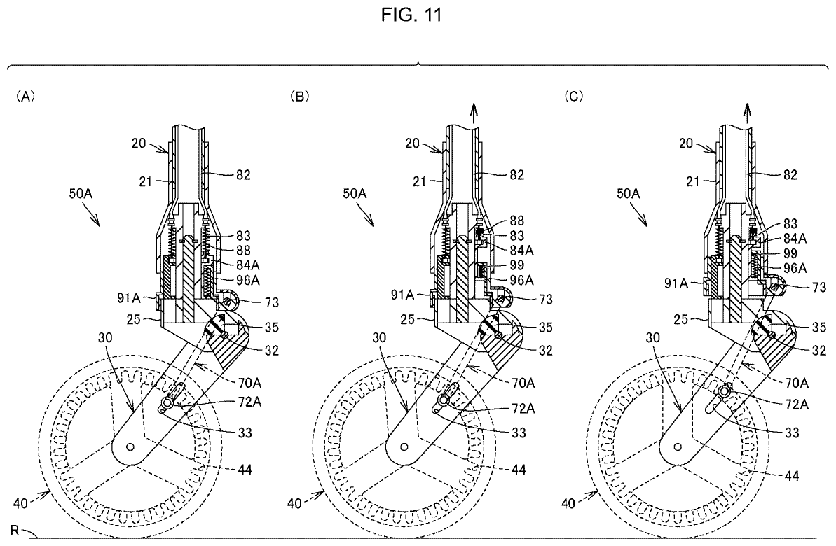

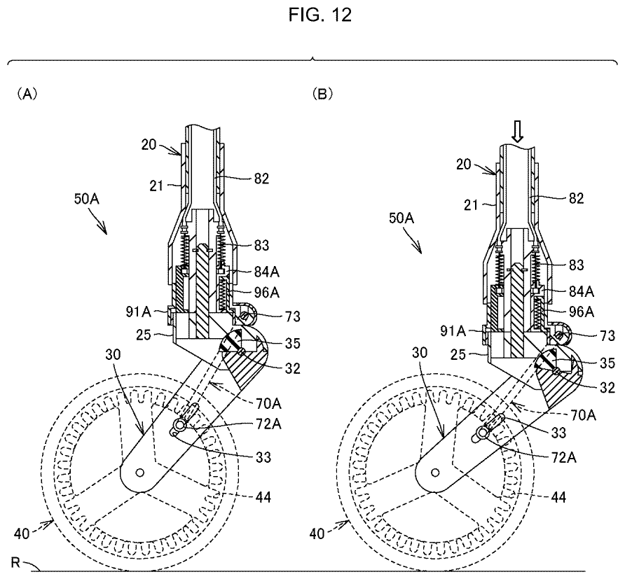

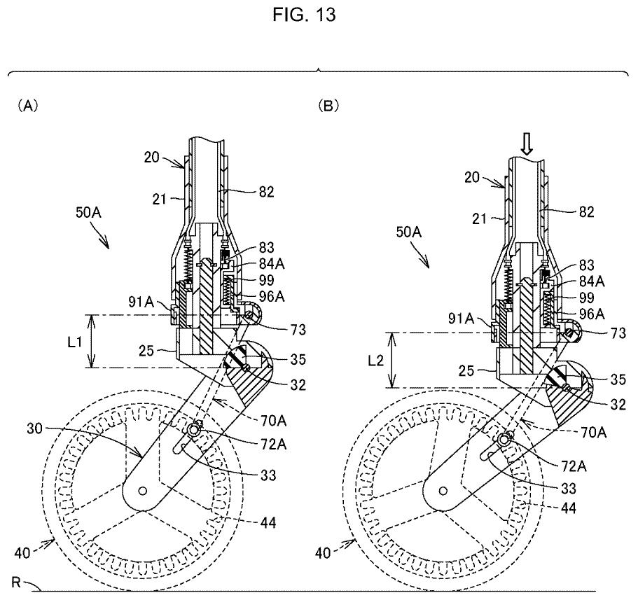

The operation of the brake mechanism 50A according to the present embodiment will be described with reference to FIGS. 11 to 13. FIG. 11 shows the transition from the traveling state to the braking state. FIG. 12 shows the state in which a load is applied to the body frame in the traveling state. FIG. 13 shows the state in which a load is applied to the body frame in the braking state.

First, the operation for switching the stroller 1 from the traveling state to the braking state will be described with reference to FIG. 11. FIG. 11 shows the traveling state in which the lock pin 72A of the lock member 70A is disengaged from between the lock protrusions 44 of the wheel 40. In order to switch the stroller 1 from this state to the braking state, the operating member 60 shown in FIG. 4 is pressed down with a foot etc. to the position, thereby pulling the connecting member 80A upward. As a result, as shown in FIG. 11, the inner wire 83 is pulled upward. Since the inner wire 83 is fixed to the moving member 84A, the moving member 84A moves upward against the biasing force of the second biasing member 88. Moreover, since the moving member 84A is connected to the rotating member 91A so as to be rotatable and movable in the up-down direction, the rotating member 91A moves upward with the moving member 84.

The rotating member 91A is connected to the lock member 70A via the shaft 73. As shown in FIG. 11, the lock pin 72A of the lock member 70A is in contact with the distal end of a lock protrusion 44. In this state, the lock member 70A cannot move upward from that position. Therefore, the rotating member 91A connected to the lock member 70A remains in a lower position due to the position of the lock member 70A. The moving member 84A moves upward as the inner wire 83 is pulled upward, whereas the rotating member 91A remains in the lower position due to the lock pin 72A being in contact with the distal end of the lock protrusion 44. Therefore, the first biasing member 99 disposed between the moving member 84A and the rotating member 91A and biasing the rotating member 91A upward is contracted, and the rotating member 91A is constantly biased upward.

For example, when the wheel 40 rotates from the state shown in FIG. 11, the positional relationship between the lock pin 72 and the lock protrusions 44 changes. As described above, the rotating member 91A is biased upward by the first biasing member 99. Therefore, when the positional relationship between the lock pin 72 and the lock protrusions 44 changes, there is no longer an obstacle to the upward movement of the rotating member 91A. Accordingly, as shown in FIG. 11, the rotating member 91A is moved upward by the biasing force of the first biasing member 99, and the lock pin 72A is fitted between the lock protrusions 44, whereby the braking state is attained. Even when the lock pin 72A is fitted between the lock protrusions 44, the positional relationship between the rotating member 91A and the moving member 84A is different from that in the traveling state (FIG. 11). The first biasing member 99 is extended in the traveling state, whereas the first biasing member 99 is slightly contracted in the braking state.

The brake mechanism 50A of the present embodiment is provided with the first biasing member 99 between the moving member 84A and the rotating member 91A. Therefore, even when a braking force cannot be applied due to the change in the positional relationship between the lock pin 72A and the lock protrusions 44 of the wheel 40 as shown in FIG. 11, the operating force of the operating member 60 is transmitted to the lock member 70A through the first biasing member 99, and is not directly transmitted to the lock member 70A. This can reduce the possibility of malfunction of the members constituting the brake mechanism 50A.

Next, the operation when a load is applied to the body frame 10 while the brake mechanism 50A is in the traveling state will be described with reference to FIG. 12. As shown in FIG. 12, when a load is applied to the leg 11 etc. due to, for example, movement of an infant riding in the stroller 1, the arm member 30 held by the caster pivoting member 25 pivots about the pivot shaft 32, and the elastic member 35 is pressed against the lower surface of the caster pivoting member 25. As a result, the tilt angle of the arm member 30 with respect to the road surface R decreases. The elastic member 35 biases the arm member 30 in such a direction that the upper end of the arm member 30 approaches the ground, that is, in such a direction that the tilt angle of the arm member 30 reaches the angle shown in FIG. 12. Therefore, when the load is removed, the arm member 30 returns to the state shown in FIG. 12 due to the elastic force of the elastic member 35.

As described above, the elastic member 35 is provided between the arm member 30 and the caster pivoting member 25. Therefore, even when a load is applied to the stroller 1, the load can be absorbed by the elastic member 35. This operation is an operation that takes place even when there is, for example, a level difference on a road surface, and may also apply in the case of FIG. 13 described below.

Lastly, the operation when a load is applied to the body frame 10 while the brake mechanism 50A is in the braking state will be described with reference to FIG. 13. As shown in FIG. 13, when a load is applied to the leg 11 etc. due to, for example, movement of an infant riding in the stroller 1, the arm member 30 held by the caster pivoting member 25 pivots about the pivot shaft 32, and the elastic member 35 is pressed against the lower surface of the caster pivoting member 25. As a result, the tilt angle of the arm member 30 with respect to the road surface R decreases. The positional relationship between the pivot shaft 32 and the shaft 73 also changes. Specifically, the height difference between the pivot shaft 32 and the shaft 73 increases from L1 to L2 (L2>L1). Namely, the shaft 73 moves away from the pivot shaft 32. Since the rotating member 91A is constantly biased upward by the first biasing member 99, the shaft 73 and the rotating member 91A are moved upward by the first biasing member 99. That is, the shaft 73 and the rotating member 91A are moved upward with respect to the pivot shaft 32 by the first biasing member 99 according to the rotation of the arm member 30. Therefore, even when a load is applied to the stroller 1, the braking state in which the lock pin 72A of the lock member 70A is fitted between the lock protrusions 44 of the wheel 40 can be maintained.

As described above, the first biasing member 99 is provided between the moving member 84A and the rotating member 91A. Therefore, even when a load is applied to the stroller 1 in the braking state, the braking state can be maintained. Moreover, the load applied to the stroller 1 can also be absorbed by the first biasing member 99.

### Effects

In the brake mechanism 50A of the present embodiment, each of the pair of arm members 30 is pivotally held via a corresponding one of the pivot shafts 32 at the lower end of a corresponding one of the pair of caster pivoting members 25. Therefore, the brake mechanism 50A is not interfered with by the pivoting motion of the pair of arm members 30. Moreover, even when a load is applied to the stroller 1 and the pair of arm members 30 pivots about their pivot shafts 32, a braking operation can be performed using the operating member 60, and the braking state can be reliably maintained.

The elongated member 81 of the present embodiment is provided at a position different from the swivel axis L. However, the elongated member 81 is connected to the driven member 90A configured to be rotatable relative to the moving member 84A to which the inner wire 83 is connected. The driven member 90A is connected to the lock member 70A. This configuration can reduce or eliminate the possibility of twisting of the elongated member 81.

The connecting member 80A of the present embodiment passes through a position different from the swivel axis L, and is disposed at a position adjacent to the caster shaft 26. This allows the brake mechanism 50A to be attached later. Moreover, since the rotating member 91A protrudes beyond the outer peripheral surface of the caster holding member 21, repair work can be easily performed even in case of malfunction.

### Third Embodiment

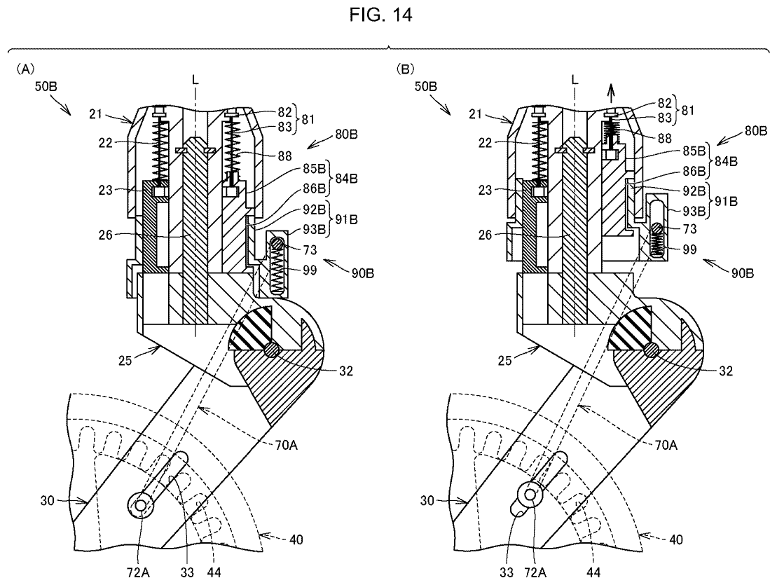

The configuration and operation of a brake mechanism 50B according to a third embodiment will be described with reference to FIG. 14. The brake mechanism 50B of the present embodiment has the same basic configuration as the brake mechanism 50A of the second embodiment. The brake mechanism 50B of the present embodiment is different from the brake mechanism 50A of the second embodiment in the configurations of a moving member 84B and a rotating member 91B. The same configurations as those of the brake mechanism 50A of the second embodiment are denoted by the same signs, and only the differences will be described in detail.

### Configurations

Like the moving member 84A of the first embodiment, the brake mechanism 50B of the present embodiment moves in response to an operation of the operating member 60 (FIG. 4). As shown in FIG. 14, an end of the elongated member 81 is connected to the upper end of the moving member 84B. The moving member 84B is a member that is movable in the up-down direction. The moving member 84B includes a wire fixing portion 85B to which the end of the elongated member 81 is connected, and a groove 86B that rotatably holds the rotating member 91B. The groove 86B is provided on the radially outer side.

The rotating member 91B has substantially the same shape as the rotating member 91A of the second embodiment, but an upper housing 92B of the rotating member 91B is held in the groove 86B of the moving member 84B. The rotating member 91B therefore moves in the up-down direction with the upward and downward movement of the movable member, and rotates relative to the moving member 84B in conjunction with rotation of the caster pivoting member 25.

A housing space for housing the shaft 73 of the lock member 70A and the first biasing member 99 is provided inside a lower cylindrical body 93B. The first biasing member 99 biases the shaft 73 toward an upper position, that is, an engaged position, and supports the shaft 73 from below.

### Operation

Referring to FIG. 14, the operation for switching the brake mechanism 50B according to the third embodiment from the traveling state to the braking state will now be described. FIG. 14 shows the traveling state in which the lock pin 72A of the lock member 70A is disengaged from between the lock protrusions 44 of the wheel 40. In order to switch the stroller 1 from this state to the braking state, the operating member 60 shown in FIG. 4 is pressed downward with a foot etc., thereby pulling the connecting member 80 upward. As a result, the inner wire 83 is pulled upward, as shown in FIG. 14. Since the inner wire 83 is fixed to the movable member 84B, the movable member 84B moves upward against the biasing force of the second biasing member 88. Furthermore, since the rotating member 91B is configured to be movable in the up-down direction with the movable member 84B and rotatable relative to the movable member 84B, the rotating member 91B moves upward with the movable member 84B.

The rotating member 91B holds the shaft 73 of the lock member 70A. As shown in FIG. 14, the lock pin 72A of the lock member 70A is in contact with the distal end of a lock protrusion 44. In this state, the lock member 70 cannot move upward from that position. Therefore, the first biasing member 99 is contracted by the shaft 73 of the lock member 70A.

For example, when the wheel 40 rotates from the state shown in FIG. 14, the positional relationship between the lock pin 72A and the lock protrusions 44 changes. As described above, the shaft 73 of the lock member 70A is biased upward by the first biasing member 99. Therefore, when the positional relationship between the lock pin 72A and the lock protrusions 44 changes, the shaft 73 of the lock member 70A is moved upward by the biasing force of the first biasing member 99, and the lock pin 72A is fitted between the lock protrusions 44, whereby the braking state is attained. The operation when a load is applied to the body frame 10 is the same as that in the brake mechanism 50A of the second embodiment.

### Modifications of Embodiments

In all of the above embodiments, the wheel has been described as a caster. However, the wheel may be a wheel that does not rotate about the swivel axis. Although a single-wheel configuration has been described as an example, the present invention may have a dual-wheel configuration in which two wheels are provided for one caster mechanism 20, and the number of wheels is not limited. Even when a plurality of wheels is provided for one caster mechanism 20, the arm member 30 may have any structure as long as the arm member 30 is provided at both ends in the width direction of the wheels and sandwiches the wheels.

In all of the above embodiments, the arm member 30 has been described as being held by the caster pivoting member 25 of the caster mechanism 20. However, the arm member 30 need not necessarily be held by the caster pivoting member 25. For example, the arm member 30 may be held at the lower end of the leg 11 with another member interposed therebetween. Each arm member 30 need only be held at the lower end of a corresponding one of the pair of legs.

In all of the above embodiments, the connecting members 80, 80A, and 80B of the brake mechanism 50, 50A, and 50B have been described as including the elongated member 81, and also including the pair of moving members 84, 84A, and 84B and the pair of driven members 90, 90A, and 90B, respectively. However, the connecting members 80, 80A, and 80B may have any structure as long as they connect the operating member 60 with the pair of lock members 70, 70A. For example, the operating member 60 and the pair of lock members 70, 70A may be directly connected by a wire etc.

In the above embodiments, the two biasing members 88, 99 are provided. However, the biasing members 88, 99 need not necessarily be provided in the brake mechanisms 50, 50A, and 50B. The presence or absence of the biasing members can be selected according to the required precision of the brake mechanism.

The connecting member 80 of the brake mechanism 50 of the first embodiment passes through the swivel axis L, and the connecting members 80A, 80B of the brake mechanisms 50A, 50B of the second and third embodiments pass through a position different from the swivel axis L. However, the connecting member 80 of the brake mechanism 50 may pass through a position different from the swivel axis L, and the connecting members 80A, 80B of the brake mechanisms 50A, 50B may pass through the swivel axis L.

In all of the above embodiments, the lock member 70 has been described as a rod-shaped member extending in the up-down direction. However, another member may be interposed between the lock pin 72 and the shaft 73 and between the lock pin 72A and the shaft 73. The lock protrusions 44 of the wheel 40 have been described as being provided in a radial pattern along the inner periphery of the tire 42. However, the rock protrusions 44 may be provided on the axle 41, or may be configured as holes. The shapes and locking directions of the lock protrusions 44 and the lock member 77 are not limited.

In the second embodiment, it has been described that the rotating member 91A, the first biasing member 99, and the cooperative member 96A form a driven member. However, not all of these components necessarily need to be configured to be rotatable relative to the moving member 84A, and part of the components may be fixed to the movable member 84A so as not to rotate.

Although some embodiments have been described in the present specification, configurations of these embodiments may be extracted and combined as appropriate.

While the embodiments of the present invention have been described above with reference to the drawings, the present invention is not limited to the illustrated embodiments. Various changes and modifications may be made to the illustrated embodiments without departing from the spirit and scope of the invention.

1. A wheeled childcare device comprising:
a body frame including a pair of legs disposed spaced apart from each other in a width direction;
a caster mechanism including a pair of caster holding members and a pair of caster pivoting members, and configured to allow a pair of wheels to swivel, each of the pair of caster holding members being provided at a lower end of a corresponding one of the pair of legs, each of the pair of caster pivoting members being pivotally held by a corresponding one of the pair of caster holding members about a swivel axis extending in an up-down direction, and each of the pair of caster pivoting members supporting a corresponding one of the pair of wheels on a shaft; and
a brake mechanism configured to stop rotation of the pair of wheels, and including a pair of lock members, an operating member, and a connecting member, the pair of lock members each configured to displace between an engaged position at which the lock member is engaged with the wheel and a disengaged position at which the lock member is disengaged from the wheel, the operating member being configured to move the pair of lock members from the disengaged position to the engaged position, and the connecting member connecting the operating member with the pair of lock members, wherein
the connecting member includes
a pair of moving members configured to move in response to an operation of the operating member,
an elongated member connecting the operating member with the pair of moving members, and
a pair of driven members each configured to be rotatable relative to a corresponding one of the pair of moving members, and each configured to follow movement of the corresponding one of the pair of moving members, and
each of the pair of lock members is connected to a corresponding one of the pair of driven members, and is configured to be displaceable between the engaged position and the disengaged position in conjunction with movement of the corresponding one of the pair of driven members.

2. The wheeled childcare device according to claim 1, wherein
the driven member includes
a rotating member configured to be rotatable relative to the moving member,
an up-down moving member configured to be movable in the up-down direction relative to the rotating member, and
a first biasing member configured to bias the up-down moving member upward relative to the rotating member.

3. The wheeled childcare device according to claim 1, wherein
the driven member includes
a rotating member provided with a lock support portion that supports a shaft of the lock member, the rotating member being configured to be rotatable relative to the moving member, and
a first biasing member configured to bias the lock member in a direction toward the engaged position.

4. The wheeled childcare device according to claim 1, wherein
the elongated member passes through the swivel axis of the caster mechanism.

5. The wheeled childcare device according to claim 1, wherein
the connecting member further includes a pair of second biasing members each configured to bias a corresponding one of the pair of moving members in such a direction that a corresponding one of the pair of lock members moves toward the disengaged position.

6. The wheeled childcare device according to claim 1, wherein
the lock member includes
a lock pin configured to displace between the engaged position and the disengaged position relative to the wheel, and
a lock body extending in a longitudinal direction from the lock pin and configured to be pivotable relative to the driven member.

7. The wheeled childcare device according to claim 6, wherein
the moving member, the driven member, and a shaft of the lock member pass through the swivel axis of the caster mechanism.
